(19) United States
(12) Patent Application Publication
(10) Pub. No.: US 2006/0104618 A1
(43) Pub. Date: May 18, 2006

(54) DVD recording/reproducing device capable of indicating CD'S auxiliary information

(75) Inventor: Eung-Sun Kim, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 10/985,885

(22) Filed: Nov. 12, 2004

(51) Int. Cl. H04N 5/781

(52) U.S. Cl. 386/125; 386/126

(57) ABSTRACT

A DVD reproducing apparatus capable of displaying auxiliary information regarding a compact disk (CD), the DVD reproducing apparatus being capable of converting an image signal and an audio signal to a certain format to record at a memory device, and having a decoder part for reproducing each of image signal and audio signal from a DVD player through a screen and a speaker. The DVD reproducing apparatus comprises a control part for controlling such that the auxiliary information included in the audio signal from the decoder part is displayed on the screen when the audio signal is reproduced. When an audio CD is reproduced, the DVD reproducing apparatus displays the auxiliary information included in the audio CD on a screen of an image display apparatus such as a television, so that a listener can obtain the information on the audio CD and can easily select desired music via a menu in the form of a GUI on the screen of the image display apparatus.

### BACKGROUND OF THE INVENTION

1. Field of the Invention

The present invention relates to a digital versatile disk (DVD) reproducing apparatus. More particularly, the present invention relates to a DVD reproducing apparatus capable of indicating on a screen auxiliary information of an audio compact disk (CD) when reproducing the audio CD.

2. Description of the Related Art

Several different media have been introduced for recording video and audio signals. These include a video tape for an analogue system, a CD for storing data formatted according to the MPEG-1 standard, and a DVD for storing image and audio signals of high capacity and quality. The CD has been introduced as a medium for storing an audio file, and most currently produced music records are produced on CDs. The DVD is mainly used as a medium for storing image and audio signals of high quality, and has substantially replaced the videotape in analogue systems. A DVD reproducing apparatus can generally reproduce an audio signal from a CD.

A DVD reproducing apparatus works with a screen (display device) and at least one speaker for reproducing the video and audio signals stored on the DVD. As such, the DVD reproducing apparatus is generally connected to an image display device, such as a television. The DVD reproducing apparatus decodes video and audio signals stored on the DVD medium according to an MPEG format, formats (or encodes) the decoded signals to either or both of the National Television System Committee (NTSC) or Phase Alternation Line (PAL) formats, and provides an image display apparatus, such as a television, with the formatted signals.

When an audio CD is inserted into the DVD reproducing apparatus, a conventional DVD reproducing apparatus recognizes the insertion of the CD and reproduces the music encoded thereon. While the music is being reproduced, however, no information regarding the CD is displayed on the screen of the image display apparatus. Generally only the logo screen of the manufacturer of the DVD reproducing apparatus appears on the screen of the image display apparatus. As such, a listener who uses a DVD reproducing apparatus to listen to the audio CD has no way of knowing how many songs are stored on the CD, nor of the track time for each song. Thus, when an audio CD is inserted into a conventional DVD reproducing apparatus, the conventional DVD reproducing apparatus can reproduce the audio signal recorded on the CD, but the listener does not have access to any auxiliary information about the reproduced audio signal. Accordingly, a need exists for such a device.

### SUMMARY OF THE INVENTION

The present invention has been developed in order to solve the problems discussed above and others associated with the conventional DVD reproducing apparatus. An aspect of the present invention is to provide a DVD reproducing apparatus capable of indicating auxiliary information about an audio CD when a DVD reproducing apparatus reproduces audio encoded on a CD.

According to an aspect of the present invention, there is provided a DVD reproducing apparatus capable of displaying auxiliary information of a compact disk (CD), the DVD reproducing apparatus capable of converting an image signal and an audio signal to a certain format to record in a memory device, the DVD reproducing apparatus comprising a decoder part for reproducing both an image signal and an audio signal from the DVD player through a screen and a speaker, a control part for controlling such that the auxiliary information included in the audio signal from the decoder part is displayed on the screen when the audio signal is reproduced.

The DVD reproducing apparatus according to an aspect of the present invention further comprises a key input part for receiving a key input signal to select one of the auxiliary information displayed on the screen. The control part of the DVD reproducing apparatus according to an aspect of the present invention comprises a flash read-only-memory (ROM) for storing a menu program corresponding to the auxiliary information included in the audio signal, and a microprocessor for detecting the auxiliary information received from the DVD player and for loading the menu program stored at the flash ROM according to the detected auxiliary information to output the program to the decoder part.

The DVD reproducing apparatus is capable of reproducing an audio file in both MPEG-1 and MP3 formats from a medium that stores the audio files therein. The auxiliary information can comprise the number of audio signals stored on the medium, the size of the stored audio signals, and the playing time of the audio signals.

### BRIEF DESCRIPTION OF THE DRAWINGS

The above aspects and features of the present invention will be more apparent by describing certain embodiments of the present invention with reference to the accompanying drawings, in which:

FIG. 1 is a conceptual diagram of a format for storing an audio signal on an audio CD;

FIG. 2 is a block diagram of a DVD reproducing apparatus according to an embodiment of the present invention;

FIG. 3 is a plan view of a remote controller of the DVD reproducing apparatus of FIG. 2; and

FIG. 4 is a CD menu screen for use with the DVD reproducing apparatus that appears on a screen when generated by an application program stored at in a flash ROM.

### DETAILED DESCRIPTION OF THE EXEMPLARY EMBODIMENTS

Certain embodiments of the present invention will be described in greater detail with reference to the accompanying drawings. Throughout the drawings, like reference numbers will be understood to refer to similar features and structures.

In the following description, same drawing reference numerals are used for the same elements even in different drawings. The matters defined in the description such as a detailed construction and elements are provided to assist in a comprehensive understanding of the invention. Thus, it is apparent that the present invention can be carried out without those defined matters. Also, well-known functions or constructions are not described in detail for purposes of conciseness.

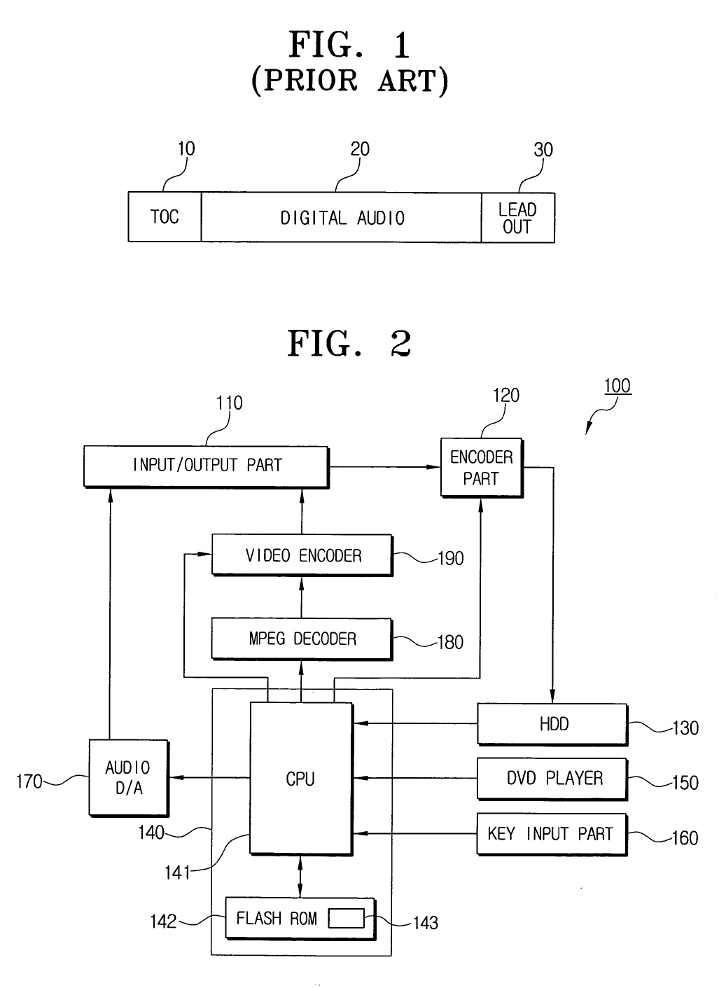

FIG. 1 is a conceptual diagram of a format for storing an audio signal on an audio CD. FIG. 1 shows an audio CD standard suggested by Sony Corporation of Japan and Philips Corporation of the Netherlands. The audio CD standard is referred to as the CD-DA standard.

The reference numeral 10 is a table of content (TOC) region, and contains information on the number of audio signals stored in the audio CD in the form of a file, the file size of the stored audio signal and the file name. The reference numeral 20 refers to a region where the music data (digital audio) is stored on the audio CD (i.e., where the audio signal is stored). The stored audio signal has a sampling frequency of 44.1 KHz, and can comprise a stereo digital data word of 16 bits. The reference numeral 30 denotes the time when all the music data (digital audio) stored on the audio CD is finished (i.e., at the end of the last music track), and is generally referred to as “lead-out”. Only logic levels of “0” are recorded at the lead-out for approximately for one minute and thirty seconds. The lead-out lets the audio CD reproducing apparatus recognize the termination of music data.

FIG. 2 is a block diagram of a DVD reproducing apparatus 100 according to an embodiment of the present invention. The DVD reproducing apparatus 100 comprises an input/output part 110, an encoder part 120, a hard disk drive (HDD) 130, a control part 140, a DVD player 150, a key input part 160, an audio D/A conversion part 170, an MPEG decoder 180 and a video encoder 190.

The input/output part 110 receives various image signals, and outputs the image signal received from the video encoder 190 to external components such as a monitor screen. The input/output part 110 can also receive a transmitted broadcasting signal and a broadcasting signal and composite signal applied from a video player (not shown). The input/output part 110 outputs the received signals to the encoder part 120, or outputs a composite signal generated by the video encoder 190 to an image display apparatus such as a television. When a broadcasting signal is applied from a receiving apparatus such as a tuner (not shown), the input/output part 110 divides the signals into an image signal and an audio signal.

The encoder part 120 converts an analog image signal received from the input/output part 110 to a digital signal, and compresses the converted signal according to an MPEG format. An example of such an MPEG format is the MPEG-2 format. In general, image signals that are formatted according to MPEG formats are compressed to increase storage utilization when the signal is stored in a storing medium such as a hard disk drive (HDD) 130.

The HDD 130 stores the MPEG-formatted image signal as a file. MPEG-formatted image signals applied to the input/output part 110 can be stored directly. In an embodiment of the present invention, the HDD 130 stores an MPEG-2 formatted image signal as a file. The type of format used with the digital video files, however, should not be considered as limiting. Various formats can be applied such as MPEG-1, MPEG-2, MPEG-3 and MPEG-4. Also, although the encoder part 120 and the MPEG decoder 180 according to an embodiment of the present invention encode and decode according to the MPEG-2 format, this too should not be considered as limiting. It is possible to encode and decode according to various formats such as MPEG-1, MPEG-3 and MPEG-4.

The DVD player 150 reads a video/audio signal stored in the MPEG format from a DVD medium. The DVD player 150 can also read a digital audio signal from an audio CD when the audio CD (CD-DA) is inserted. When an audio CD is inserted into the DVD player 150, the control part 140 perceives the insertion and outputs a menu program to the video encoder 190. The video encoder 190 processes the menu program, converts the program to a format such as an NTSC/PAL format that can be reproduced on a screen of an image display apparatus such as a television, and outputs the audio signal to the audio D/A conversion part 170.

When video/audio signal compressed according to an MPEG-2 format is read by the DVD player 150 and then applied to the control part 140, the control part 140 outputs the signal to the MPEG decoder 180. The key inputting part 160 receives a control signal generated from a remote control device (not shown) for controlling the DVD reproducing apparatus 100 and a setting key of the DVD reproducing apparatus 100 and outputs the signal to the control part 140.

When an audio CD is reproduced at a DVD player 150, the audio D/A conversion part 170 receives a digital audio signal from the control part 140 and converts the signal to an analogue format to output the signal to the input/output part 110. The audio signal converted to an analogue format is transmitted to a speaker (not shown) connected with the input/output part 110, or a connecting terminal (not shown) of an image display apparatus connected with the input/output part 110.

MPEG decoder 180 receives MPEG encoded signals via the control part 140 and decompresses the MPEG compressed signals according to algorithms well known to those skilled in the art. This occurs when a DVD medium is inserted into the DVD player 150, or when a video and audio MPEG formatted signal of stored on a DVD medium or the HDD 130 is applied to the MPEG decoder 180. The MPEG decoder 180 receives the signals via the control part 140 and decompresses the MPEG compressed signals. The video encoder 190 converts the decompressed video and audio signals output from the MPEG decoder 180 to a format such as NTSC or PAL that can be reproduced by an image display apparatus such as a television. The converted image signal and audio signal are applied to the input/output part 110, and reproduced through a screen (not shown) or a speaker (not shown) of an image display apparatus (not shown) connected with the input/output part 110.

The control part 140 can comprise a microprocessor 141 and a flash ROM 142. Alternatively, the control part 140 can comprise a controller, central processing unit (CPU), micro-controller or any other programmable type device. The flash ROM 142 stores an operation system for driving the DVD reproducing apparatus 100, and has a certain application program such as a graphic user interface (GUI) for displaying the file information stored at the TOC region 10 of an audio CD on a screen (TOC region display program 143).

When an audio CD is inserted into the DVD player 150, the microprocessor 141 perceives the insertion. The microprocessor 141 perceives the audio CD and then reads out the TOC region display program 143 from the flash ROM 142 for displaying TOC region 10 information. The TOC region display program 143 stored in the flash ROM 142 can be a program that operates under a GUI environment. The microprocessor 141 loads the information stored at the TOC region 10 of the CD according to the TOC region display program 143 and processes the TOC information 10 of CD to display on a screen, and outputs the information to the video encoder 190.

When an audio CD is inserted into a DVD player 150, the DVD reproducing apparatus 100 having the above construction according to an embodiment of the present invention displays the TOC information 10 of the audio CD in the form of a GUI on a screen of an image display apparatus such as a television, and reproduces the audio signal stored on the audio CD through a speaker of the image display apparatus. A screen in the form of a GUI according to an embodiment of the present invention will now be described in greater detail.

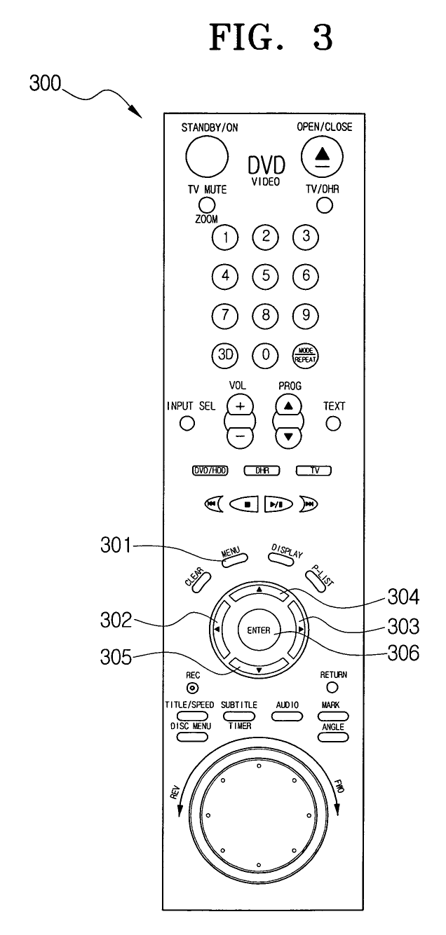

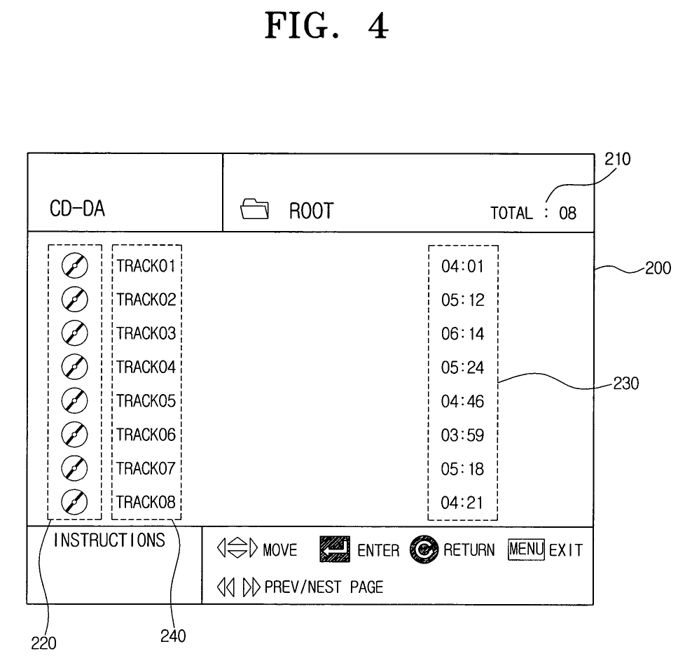

A CD menu screen having a GUI form will be explained with reference to FIG. 3, in which a remote controller is depicted that is an input device for the DVD reproducing apparatus 100 according to an embodiment of the present invention. Referring to FIG. 3, the remote controller 300 comprises a menu key 301 for instructing to load and close the CD menu screen, left, right, up and down direction keys 302, 303, 304 and 305 for instructing movement between menus on the CD screen, an enter key 306 for selecting a menu, a return key 307 for returning the present screen to the previous screen and other keys. The other keys include general or specific keys for operating an image recording/reproducing apparatus (not shown) and an image display apparatus such as a television. Therefore, the functions of the other keys can be easily understood by the alphabetic marks adjacent to each key, as one skilled in the art can appreciate. Although a detailed description of the function of each of thee other keys is omitted, those skilled in the art of the present invention will be able to understand their function, as well as operation of the present invention. Therefore, a detailed description will be omitted. Hereinafter, the CD menu screen depicted in FIG. 4 will be explained with reference to the remote controller of FIG. 3.

FIG. 4 is a CD menu screen for use with the DVD reproducing apparatus that appears on a screen when generated by an application program stored at in a flash ROM. When an audio CD is inserted into the DVD player 150, the number 210 of reproducible audio signals (i.e., songs) is displayed on the screen according to the information stored at the TOC region 10 of the audio CD. The icons 220 also appear for easy recognition by a user. The icons 220 represent eight (8) CD media. The reproducing time 230 indicates time length of each audio signal stored on the audio CD. The titles 240 are also given for each of the respective audio signals, and are initially set to TRACK01, TRACK02 . . . TRACK08 as default values. A cursor is initially located on the first track, TRACK01, in the absence of input from the remote controller 300. A user can press the up and down direction keys 304 and 305 of the remote controller 300 to move the cursor to one of the TRACKS (TRACK01 to TRACK08). If the enter key 306 is pressed while the cursor is on a TRACK key, the TRACK under the cursor key is selected and reproduced. Therefore, when an audio CD is reproduced in the DVD reproducing apparatus 100 according to an embodiment of the present invention, a user can obtain the information regarding the audio CD from the screen while listening to the music through a speaker, and select whatever songs may be present on the audio CD.

When an audio CD is reproduced on a DVD reproducing apparatus 100 according to an embodiment of the present invention, the auxiliary information stored on the audio CD (for example the TOC information 10) is displayed on a screen of an image display apparatus such as a television. The user therefore knows the TOC information 10 regarding the audio CD, and can easily select desired music through a menu displayed in the form of a GUI on the screen of the image display apparatus.

The DVD reproducing apparatus 100 is capable of reproducing an audio file in both MPEG-1 and MP3 formats from a medium that stores the audio files therein. The auxiliary information can comprise the number of audio signals stored on the medium, the size of the stored audio signals, and the playing time of the audio signals.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and the many alternatives, modifications, and variations that will be apparent to those skilled in the art.

What is claimed is:

1. A DVD reproducing apparatus capable of displaying auxiliary information of a compact disk (CD), the DVD reproducing apparatus being capable of converting an image signal and an audio signal to a predetermined format, and to record the signals onto a memory device, and having a decoder part for reproducing each of an image signal and audio signal from a DVD player through a display device and a speaker, comprising:
a control part for controlling the apparatus such that the auxiliary information included in the audio signal from the decoder part is displayed on the display device when the audio signal is reproduced.

2. The apparatus as claimed in claim 1, further comprising a key input part for receiving a key input signal to select one of the auxiliary information displayed on the screen.

3. The apparatus as claimed in claim 1, wherein the control part comprises:
a flash ROM for storing a menu program corresponding to the auxiliary information included in the audio signal; and
a microprocessor for detecting the auxiliary information received from the DVD player and loading the menu program stored at the flash ROM according to the detected auxiliary information to output the program to the decoder part.

4. The apparatus as claimed in claim 1, wherein the DVD player is capable of reproducing an audio file in both MPEG-1 and MP3 formats from a medium that stores the file therein.

5. The apparatus as claimed in claim 1, wherein the auxiliary information comprises:
a number of audio signals stored on the medium, a size of the stored audio signals, and a playing time of the audio signals.

6. A method for operating a DVD reproducing apparatus capable of displaying auxiliary information of a compact disk (CD), comprising:
reading auxiliary information stored on a CD; and
displaying the auxiliary information on a display device when an audio signal of the CD is reproduced.

7. The method according to claim 6, wherein the step of reading auxiliary information on a CD comprises:
reading and running an auxiliary display program stored in the DVD reproducing apparatus; and
processing the auxiliary information such that it can be displayed.

8. The method according to claim 6, wherein the step of displaying the auxiliary information on a screen comprises:
encoding the processed auxiliary information so that it can be displayed; and
displaying the encoded processed auxiliary information according to a graph user interface (GUI) environment.

9. The method according to claim 6, wherein the step of displaying the auxiliary information on a screen comprises:
generating a GUI environment according to a stored program in the DVD playing apparatus;
processing the auxiliary information stored on the CD to discern the auxiliary information regarding the audio files; and
displaying in separate areas on a display the auxiliary information in a GUI environment.

10. The method according to claim 6, wherein the auxiliary information comprises table of contents information of the stored audio files on the CD.

11. The method according to claim 10, wherein the table of contents information of the stored audio files on the CD comprises:
a number of audio signals stored on the medium, a size of the stored audio signals, and a playing time of the audio signals
